(19) United States
(12) Patent Application Publication
(10) Pub. No.: US 2023/0367553 A1
(43) Pub. Date: Nov. 16, 2023

(54) APPARATUS AND METHOD FOR MULTIPLICATION OPERATION BASED ON OUTER PRODUCT

(71) Applicant: ELECTRONICS AND TELECOMMUNICATIONS RESEARCH INSTITUTE, Daejeon (KR)

(72) Inventor: Hye-Ji KIM, Daejeon (KR)

(73) Assignee: ELECTRONICS AND TELECOMMUNICATIONS RESEARCH INSTITUTE, Daejeon (KR)

(21) Appl. No.: 18/317,666

(22) Filed: May 15, 2023

(30) Foreign Application Priority Data
May 16, 2022 (KR) 10-2022-0059805
May 3, 2023 (KR) 10-2023-0057744

(51) Int. Cl. G06F 7/544; G06F 7/523; G06F 7/50

(52) U.S. Cl. CPC G06F 7/5443; G06F 7/50; G06F 7/523

(57) ABSTRACT

Disclosed herein are an apparatus and method for a multiplication operation based on an outer product. The apparatus may include first internal calculators, each of which generates an intermediate accumulation value by performing a Multiply-Accumulate (MAC) operation, second internal calculators, each of which generates a chunking accumulation value using the intermediate accumulation value, and accumulation data transmission paths for enabling the output of any one of the first internal calculators to be input to any one of the second internal calculators.

### CROSS REFERENCE TO RELATED APPLICATIONS

This application claims the benefit of Korean Patent Applications No. 10-2022-0059805, filed May 16, 2022, and No. 10-2023-0057744, filed May 03, 2023, which are hereby incorporated by reference in their entireties into this application.

### BACKGROUND OF THE INVENTION

### 1. Technical Field

The disclosed embodiment relates to technology for a multi-accumulation operation unit for compensating for the accuracy of a low-precision operation of an Artificial Intelligence (AI) processor.

### 2. Description of the Related Art

A quantization method is widely being used in order to accelerate training and inference of an artificial neural network and to reduce the use of memory. This is a method of processing a neural network operation using a low-precision integer or floating-point format represented with eight or fewer bits, rather than performing an operation using a 32-bit floating-point format.

Here, the floating-point format is configured with a sign (S), an exponent (E), and a mantissa (M), and the bit-width of the mantissa may be used to represent the precision of a number. That is, when the number of bits allocated for the exponent is large but the number of bits allocated for the mantissa is small, the format may represent a wide range of numbers, the interval between which is sparse. Conversely, when the number of bits allocated for the exponent is small but the number of bits allocated for the mantissa is large, the format may represent a small range of numbers with high precision.

When the quantization method is applied to an accumulation operation of a neural network, information loss by quantization increases. That is, the smaller the bit-width of the mantissa for representing the precision of accumulation operation data in a floating-point format, the greater the operation error by information loss. This issue is called ‘swamping’.

In order to alleviate swamping, a chunking accumulation method is used. As a document of the related art regarding application of the chunking accumulation method to a deep-learning accelerator, there is “Deep learning accelerator architecture with chunking GEMM” (U.S. Application Publication, US 2019-0325301).

According to the document of the related art, the chunking accumulation method is performed in such a way that, after target data on which an accumulation operation is to be performed is divided into predetermined chunks, the accumulation operation is performed on each chunk at the first stage, and the operation of accumulating the results of the accumulation operations performed on the respective chunks is performed at the second stage.

Because this process enables the accumulation values to be evenly distributed, information loss caused by a lack of precision in a floating-point addition process may be minimized.

However, because the target data on which the accumulation operation is to be performed is divided into chunks and the accumulation operation is performed on each of the chunks in the chunking accumulation method, the accumulation operation at the first stage and the accumulation operation at the second stage cannot be simultaneously performed using the same operation unit.

Therefore, each time the accumulation operation for each chunk is completed, it is necessary to store the operation result in external memory. Frequent access to the memory for this process delays the accumulation operation, which may result in a decrease in the speed of overall training and inference.

In order to solve this problem, a neural network accelerator is implemented to include hardware dedicated for chunking accumulation and to perform the two stages of accumulation operations in a calculator. However, installation of double accumulation operation circuits in all of the internal calculators of a neural network acceleration circuit causes another problem in which a hardware area is expanded.

### SUMMARY OF THE INVENTION

An object of the disclosed embodiment is to compensate for the accuracy of an accumulation operation of a neural network using a low-precision data format in an Artificial Intelligence (AI) processor.

Another object of the disclosed embodiment is to solve a problem in which the speed of training and inference is decreased by frequent memory access when a chunking accumulation method is applied in an AI processor.

A further object of the disclosed embodiment is to solve a problem in which a hardware area is expanded for a chunking accumulation operation in an AI processor.

An apparatus for a multiplication operation based on an outer product according to an embodiment may include first internal calculators, each of which generates an intermediate accumulation value by performing a Multiply-Accumulate (MAC) operation, second internal calculators, each of which generates a chunking accumulation value using the intermediate accumulation value, and accumulation data transmission paths for enabling the output of any one of the first internal calculators to be input to any one of the second internal calculators.

Here, each of the second internal calculators may receive the output of any one of the first internal calculators.

Here, each of the first internal calculators may perform a reset operation after transferring the intermediate accumulation value to one of the second internal calculators at every period corresponding to a chunk size corresponding to the intermediate accumulation value.

Here, each of the second internal calculators may perform an operation for generating the chunking accumulation value at every period corresponding to the chunk size.

Here, the operation for generating the chunking accumulation value may be an operation of adding a newly input intermediate accumulation value and an intermediate accumulation value stored in the second internal calculator.

Here, the apparatus may further include a control unit for inputting a control signal for adjusting the chunk size to each of the first internal calculators and the second internal calculators.

Here, each of the second internal calculators may be transitioned from an inactive state to an active state at every period corresponding to the chunk size.

A method for a multiplication operation based on an outer product according to an embodiment may include generating, by each of first internal calculators, an intermediate accumulation value by performing a Multiply-Accumulate (MAC) operation; transmitting the intermediate accumulation value to one of second internal calculators through an accumulation data transmission path; and generating, by each of the second internal calculators, a chunking accumulation value using the intermediate accumulation value.

Here, transmitting the intermediate accumulation value may comprise performing a reset operation after transferring the intermediate accumulation value to one of the second internal calculators at every period corresponding to a chunk size corresponding to the intermediate accumulation value.

Here, generating the chunking accumulation value may comprise performing an operation for generating the chunking accumulation value at every period corresponding to the chunk size.

Here, the operation for generating the chunking accumulation value may be an operation of adding a newly input intermediate accumulation value and an intermediate accumulation value stored in the second internal calculator.

Here, the method may further include transitioning each of the second internal calculators from an inactive state to an active state at every period corresponding to the chunk size before generating the chunking accumulation value.

An apparatus for a multiplication operation based on an outer product according to an embodiment may include first internal calculators, each of which generates an intermediate accumulation value by performing a Multiply-Accumulate (MAC) operation, second internal calculators, each of which generates a first chunking accumulation value using the intermediate accumulation value, third internal calculators, each of which generates a second chunking accumulation value using the first chunking accumulation value, first accumulation data transmission paths for enabling the output of any one of the first internal calculators to be input to any one of the second internal calculators, and second accumulation data transmission paths for enabling the output of any one of the second internal calculators to be input to any one of the third internal calculators.

Here, each of the second internal calculators may receive the output of any one of the first internal calculators, and each of the third internal calculators may receive the output of any one of the second internal calculators.

Here, each of the first internal calculators may perform a reset operation after transferring the intermediate accumulation value to one of the second internal calculators at every period corresponding to a first chunk size corresponding to the intermediate accumulation value, and each of the second internal calculators may perform a reset operation after transferring the first chunking accumulation value to one of the third internal calculators at every period corresponding to a size acquired by multiplying the first chunk size by a second chunk size, which is set for chunking accumulation of the first chunking accumulation value.

Here, each of the second internal calculators may perform an operation for generating the first chunking accumulation value at every period corresponding to the first chunk size, and each of the third internal calculators may perform an operation for generating the second chunking accumulation value at every period corresponding to a size acquired by multiplying the first chunk size by a second chunk size, which is set for chunking accumulation of the first chunking accumulation value.

Here, the operation for generating the first chunking accumulation value may be an operation of adding a newly input intermediate accumulation value and an intermediate accumulation value stored in the second internal calculator, and the operation for generating the second chunking accumulation value may be an operation of adding a newly input first chunking accumulation value and a second chunking accumulation value stored in the third internal calculator.

Here, the apparatus may further include a control unit for inputting a control signal for adjusting a chunk size corresponding to each of the first to third internal calculators or a period at which a reset operation is performed.

Here, each of the second internal calculators may be transitioned from an inactive state to an active state at every period corresponding to the first chunk size, and each of the third internal calculators may be transitioned from an inactive state to an active state at every period corresponding to a size acquired by multiplying the first chunk size by the second chunk size.

The apparatus for a multiplication operation based on an outer product according to an embodiment repeatedly adds (N+3)-th internal calculators, each of which performs an operation for generating an (N+2)-th chunking accumulation value using an (N+1)-th chunking accumulation value, and accumulation data transmission paths for enabling the output of any one of (N+2)-th internal calculators to be input to any one of the (N+3)-th internal calculators as N increases (N being an integer increasing by 1 from 1), and the operation for generating the (N+2)-th chunking accumulation value may be an operation of adding a newly input (N+1)-th chunking accumulation value and an (N+2)-th chunking accumulation value stored in the (N+3)-th internal calculators.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is an internal configuration diagram of a general apparatus for a multiplication operation based on an outer product;

FIG. 2 is a flowchart for explaining a chunking accumulation process in a general apparatus for a multiplication operation based on an outer product;

FIG. 3 is an internal configuration diagram of an apparatus for a multiplication operation based on an outer product according to an embodiment;

FIG. 4 is a flowchart for explaining a method for a multiplication operation based on an outer product according to an embodiment;

FIG. 5 is an exemplary view of vector-matrix multiplication performed in a general apparatus for a multiplication operation based on outer product;

FIG. 6 is an internal configuration diagram of an apparatus for a multiplication operation based on an outer product according to another embodiment;

FIG. 7 is an internal configuration diagram of an apparatus for a multiplication operation based on an outer product according to a further embodiment; and

FIG. 8 is a view illustrating a computer system configuration according to an embodiment.

### DESCRIPTION OF THE PREFERRED EMBODIMENTS

The advantages and features of the present disclosure and methods of achieving them will be apparent from the following exemplary embodiments to be described in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

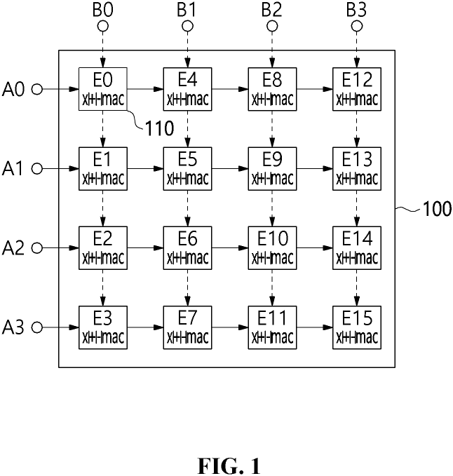

Hereinafter, an apparatus and method for a multiplication operation based on an outer product according to an embodiment will be described in detail with reference to FIGS. 1 to 8.

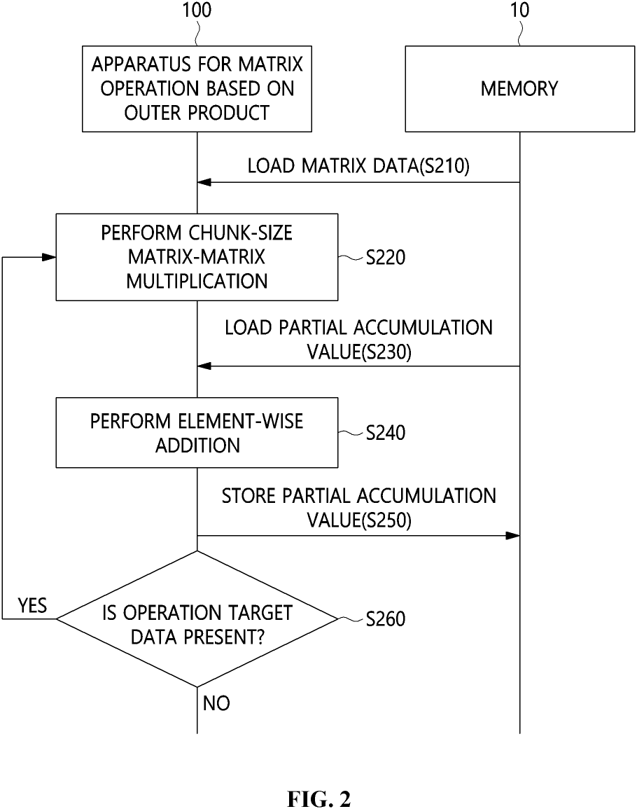

FIG. 1 is an internal configuration diagram of a general apparatus for a multiplication operation based on an outer product, and FIG. 2 is a flowchart for explaining a chunking accumulation process in a general apparatus for a multiplication operation based on an outer product.

Referring to FIG. 1, a general outer-product-based matrix calculator 100 may include multiple internal calculators 110 for performing a Multiply-Accumulate (MAC) operation.

Through the multiple internal calculators 110, a matrix-matrix multiplication operation to which a chunking accumulation method is applied may be performed.

Referring to FIG. 2, matrix data for an outer product operation is loaded from external memory 10 into the outer-product-based matrix calculator 100 at step S210.

Here, the external memory 10 may include memory 1030, storage 1060, and all kinds of external memory accessible through a network 1080, which are installed outside an apparatus 1090 for a multiplication operation based on an outer product in a computer system 1000 such as that illustrated in FIG. 8 to be described later.

Subsequently, the outer-product-based matrix calculator 100 performs a matrix-matrix multiplication operation on matrix data having a predetermined chunk size, which is a part of the loaded matrix data, at step S220.

Subsequently, the outer-product-based matrix calculator 100 loads a previously stored partial accumulation value from the external memory 10 at step S230 and performs an element-wise addition of the partial accumulation value and the result value of the matrix-matrix multiplication operation performed at step S220 at step S240.

Here, when the matrix-matrix multiplication operation is performed for the first time, there is no previously stored partial accumulation value, so steps S230 and S240 may be skipped.

Subsequently, the outer-product-based matrix calculator 100 again stores the partial accumulation value that is updated by performing the element-wise addition in the memory 10 at step S250.

Here, because the matrix-matrix multiplication operation is performed on the matrix data of the predetermined chunk size, rather than the entire matrix data loaded at step S220, when more matrix data on which the operation is to be performed is present at step S260, the outer-product-based matrix calculator 100 goes back to step S220, thereby again performing steps S220 to S250.

Alternatively, steps S250 and S260 may be performed before step S230 in FIG. 2, and, at step S240, the outer-product-based matrix calculator 100 performs element-wise addition of all of the partial accumulation values stored at step S230 and then transfers the result value of the element-wise addition back to the memory 10.

Alternatively, the outer-product-based matrix calculator 100 performs only steps S210, S220, S250, and S260 in FIG. 2, and steps S230 and S240 may be performed by an external special processor.

As described above, the conventional outer-product-based matrix calculator 100 has to store an operation result value in the external memory 10 each time a Multiply-Accumulate (MAC) operation performed on matrix data of a chunk size is terminated. Frequent memory access in this process delays the operation time, which may decrease the speed of overall training and inference. Also, an external special processor may be required for element-wise addition.

Accordingly, an embodiment proposes an apparatus and method for an outer-product-based multiplication operation that do not have to store an operation result value in external memory each time an accumulation operation for each chunk is terminated, without additional hardware.

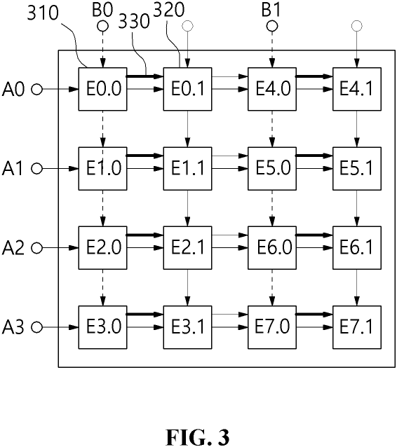

FIG. 3 is an internal configuration diagram of an apparatus for a multiplication operation based on an outer product according to an embodiment.

Referring to FIG. 3, the apparatus 300 for a multiplication operation based on an outer product according to an embodiment includes first internal calculators 310 and second internal calculators 320, and accumulation data transmission paths 330 may be formed between the first internal calculators 310 and the second internal calculators 320.

Here, although the apparatus 300 for a multiplication operation based on an outer product in which the internal calculators are arranged in a 4 × 4 structure is illustrated, this is merely an example for helping understanding of the embodiment, and the present disclosure is not limited thereto.

Also, the first internal calculators 310 may indicate calculators that receive data from two external input ports in FIG. 3, for example, E0.0, E1.0, ..., E7.0, and the second internal calculators 320 may indicate calculators that receive data from the adjacent first internal calculators 310, rather than from the external input ports, in FIG. 3, that is, E0.1, E1.1, ..., E7.1.

The apparatus 300 for a multiplication operation based on an outer product, for example, sequentially receives vector data of a first matrix through the input ports A0 to A3 and sequentially receives vector data of a second matrix through the input ports B0 to B1, thereby performing a matrix-matrix multiplication operation.

Here, the vector data of the first matrix and the data of the second matrix may include, for example, intermediate operation data of a neural network, e.g., feature map data or neural network training parameters, such as weights.

Here, the data input through the input ports may be data in a floating-point format that is quantized by adjusting the bit-width of the mantissa for representing the precision.

The apparatus 300 for a multiplication operation based on an outer product according to an embodiment adds only the accumulation data transmission paths 330 and minimizes additional other components when configuring hardware for a chunking accumulation operation. Accordingly, a problem caused by a chunking accumulation operation may be solved while using the structure of the apparatus 300 for a multiplication operation based on an outer product.

Each of the first internal calculators 310 performs a Multiply-Accumulate (MAC) operation, thereby generating an intermediate accumulation value.

The accumulation data transmission paths 330 may enable the output of any one of the first internal calculators 310 to be input to any one of the second internal calculators 320.

Accordingly, each of the first internal calculators 310 transfers the intermediate accumulation value to one of the adjacent second internal calculators 320 without storing the same in separate memory.

Accordingly, each of the second internal calculators 320 may receive the output of any one of the first internal calculators 310.

Each of the second internal calculators 320 may perform an operation for generating a chunking accumulation value using the intermediate accumulation value transferred thereto.

Here, the operation for generating the chunking accumulation value may be an operation of adding the newly input intermediate accumulation value and the intermediate accumulation value stored in the second internal calculator 320.

Here, each of the first internal calculators 310 may perform a reset operation after it transfers the intermediate accumulation value to one of the second internal calculators 320 at every period corresponding to a chunk size corresponding to the intermediate accumulation value.

Also, each of the second internal calculators 320 may perform an operation for generating the chunking accumulation value at every period corresponding to the chunk size.

That is, each of the second internal calculators 320 accumulates only the intermediate accumulation values received from one of the first internal calculators 310 at every period corresponding to the chunk size, thereby generating a final accumulation value.

To this end, the apparatus 300 for a multiplication operation based on an outer product according to an embodiment may further include a control unit (not illustrated) for inputting a control signal for adjusting the chunk size to each of the first internal calculators and the second internal calculators. According to another embodiment, the control signal may be transferred from an external control unit.

The chunk size may be adjusted depending on at least one of the type of data on which an outer-product-based multiplication operation is to be performed, the bit-width of a mantissa for representing the precision of data in a floating-point format, or various attributes including the characteristics of an application using the data, or a combination thereof.

The time at which each of the first internal calculators 310 transfers the intermediate accumulation value and the time at which it is reset may be set based on the chunk size.

The time at which each of the second internal calculators 320 performs an operation for generating the chunking accumulation value may be set based on the chunk size.

Here, each of the second internal calculators 320 may be set to be transitioned from an inactive state to an active state at every period corresponding to the chunk size.

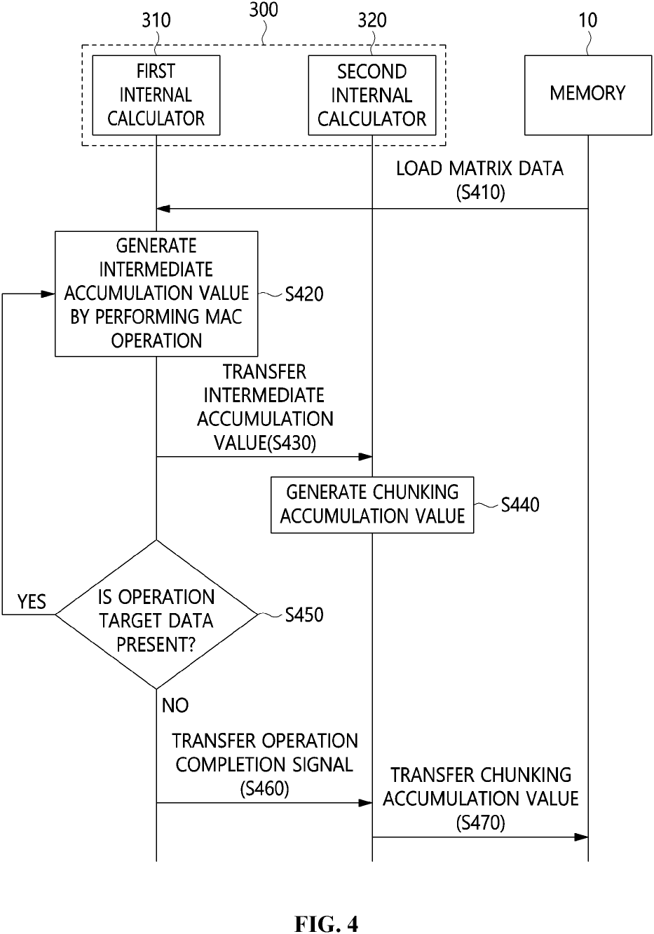

FIG. 4 is a flowchart for explaining a method for a multiplication operation based on an outer product according to an embodiment.

Referring to FIG. 4, the apparatus 300 for a multiplication operation based on an outer product according to an embodiment loads matrix data from external memory 10 at step S410.

Here, the external memory 10 may include memory 1030, storage 1060, and all kinds of external memory accessible through a network 1080, which are installed outside an apparatus 1090 for a multiplication operation based on an outer product in a computer system 1000 such as that illustrated in FIG. 8 to be described later.

Subsequently, each of the first internal calculators 310 of the apparatus 300 for a multiplication operation based on an outer product performs a Multiply-Accumulate (MAC) operation, thereby generating an intermediate accumulation value at step S420.

Subsequently, each of the first internal calculators 310 transmits the intermediate accumulation value to one of second internal calculators through an accumulation data transmission path at step S430.

Each of the second internal calculators 320 generates a chunking accumulation value using the intermediate accumulation value at step S440.

Subsequently, when operation target data is present at step S450, steps S420 to S440 may be repeatedly performed.

Conversely, when there is no operation target data at step S450, each of the first internal calculators 310 transfers an operation completion signal through the accumulation data transmission path at step S460, and each of the second internal calculators 320 transfers the chunking accumulation value, which is accumulated up to the present time, to the memory 10 as the final result value at step S470.

When the method according to the embodiment in FIG. 4 is compared with the conventional method in FIG. 2, the intermediate accumulation values are accumulated by the second internal calculators 320, so the apparatus 300 for a multiplication operation based on an outer product does not have to access external memory in the embodiment described above.

Also, an element-wise addition process is skipped, whereby the result value may be simply acquired.

Meanwhile, the conventional outer-product-based matrix calculator 100 shown in FIG. 1 may calculate an accumulation value of an LxL-dimension matrix at every cycle. Here, L indicates the number of input ports. For example, because the outer-product-based matrix calculator 100 in FIG. 1 has four input ports A0 to A3, an accumulation value of a 4x4-dimension matrix may be calculated at every cycle.

In contrast, the outer-product-based matrix calculator 300 according to the embodiment illustrated in FIG. 3 may calculate an accumulation value of an Lx(L/2)-dimension matrix at every cycle. This is because each of the second internal calculators 320 is used for chunking accumulation of the intermediate values received from one of the first internal calculators 310, rather than receiving data from the outside.

However, because the delay time caused by external memory access is decreased, as described above, the overall operation speed may be improved.

Furthermore, because a chunking accumulation method for alleviating swamping that is caused by applying a quantization method to an accumulation operation of a neural network is applied as described above, an accurate operation result in which an error resulting from quantization is reduced may be acquired.

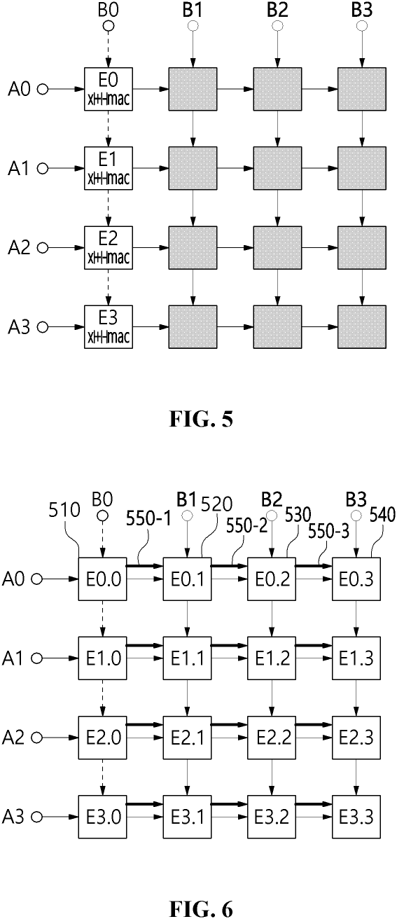

FIG. 5 is an exemplary view of vector-matrix multiplication performed in a general apparatus for a multiplication operation based on an outer product.

The general outer-product-based multiplication operator 100 illustrated in FIG. 1 is a structure optimized to efficiently process matrix-matrix multiplication. Therefore, when a vector-matrix multiplication operation is performed in the same hardware structure as the conventional outer-product-based multiplication operator 100, as illustrated in FIG. 5, the utilization of internal calculators cannot reach 100%, and only a part thereof is used. For example, only the internal calculators E0 to E3 are used, and the remaining internal calculators are not used.

Accordingly, in the embodiment, the internal calculators that are not used for a vector-matrix multiplication operation are used for a multi-accumulation operation. That is, using the internal calculators that are not used, a chunking accumulation method is applied.

FIG. 6 is an internal configuration diagram of an apparatus for a multiplication operation based on an outer product according to another embodiment.

Referring to FIG. 6, the apparatus 500 for a multiplication operation based on an outer product according to another embodiment includes first internal calculators 510 and second internal calculators 520, and accumulation data transmission paths 550-1 may be formed between the first internal calculators 510 and the second internal calculators 520.

Also, the apparatus 500 for a multiplication operation based on an outer product according to another embodiment includes third internal calculators 530, and accumulation data transmission paths 550-2 may be formed between the second internal calculators 520 and the third internal calculators 530.

Also, the apparatus 500 for a multiplication operation based on an outer product according to another embodiment includes fourth internal calculators 540, and accumulation data transmission paths 550-3 may be formed between the third internal calculators 530 and the fourth internal calculators 540.

Also, the first internal calculators 510 may indicate calculators that receive data from two external input ports in FIG. 6, for example, E0.0, E1.0, ..., E3.0, the second internal calculators 520 may indicate calculators that receive data from the adjacent first internal calculators 510, rather than from the external input ports, in FIG. 6, that is, E0.1, E1.1, ..., E3.1, the third internal calculators 530 may indicate calculators that receive data from the adjacent second internal calculators 520, rather than from the external input ports, in FIG. 6, that is, E0.2, E1.2, ..., E3.2, and the fourth internal calculators 540 may indicate calculators that receive data from the adjacent third internal calculators 530, rather than from the external input ports, in FIG. 6, that is, E0.3, E1.3, ..., E3.3.

That is, the apparatus 500 for a multiplication operation based on an outer product according to an embodiment adds only the accumulation data transmission paths 550-1, 550-2, and 550-3 and minimizes additional other components when configuring hardware for a chunking accumulation operation. Accordingly, a problem caused by a chunking accumulation operation may be solved while using the structure of the apparatus 500 for a multiplication operation based on an outer product.

Furthermore, the apparatus 500 for a multiplication operation based on an outer product according to another embodiment uses the second to fourth internal calculators 520 to 540 for high-order accumulation, thereby improving the utilization of the internal calculators and further reducing a quantization error, which is a problem with a chunking accumulation operation.

For example, when a total of 10000 pieces of data are accumulated, the first internal calculators 510 may transfer accumulation values, each being acquired by accumulating every ten pieces of data, to the second internal calculators 520. The second internal calculators 520 again accumulate every ten accumulation values, each being acquired by accumulating every ten pieces of data in the first internal calculators 510, thereby transferring accumulation values, each being acquired by accumulating a total of 100 pieces of data, to the third internal calculators 530. The third internal calculators 530 again accumulate every ten accumulation values, each being acquired by accumulating ten accumulation values in the second internal calculators 520, thereby transferring accumulation values, each being acquired by accumulating a total of 1000 pieces of data, to the fourth internal calculators 540. The fourth internal calculators 540 again accumulate ten accumulation values, each being acquired by accumulating ten accumulation values in the third internal calculators 530, thereby outputting a final value acquired by accumulating a total of 10000 pieces of data.

The second internal calculators 520 again accumulate every ten accumulation values, each being acquired by accumulating ten pieces of data, and transfer values, each being acquired by accumulating a total of 100 pieces of data, to the third internal calculators 530, and each of the first internal calculators 510 may generate an intermediate accumulation value by performing a Multiply-Accumulate (MAC) operation.

The accumulation data transmission paths 550-1 may enable the output of any one of the first internal calculators 510 to be input to any one of the second internal calculators 520.

Accordingly, each of the first internal calculators 510 transfers the intermediate accumulation value to one of the adjacent second internal calculators 520 without storing the same in separate memory.

Accordingly, each of the second internal calculators 520 may receive the output of any one of the first internal calculators 510.

Each of the second internal calculators 520 may perform an operation for generating a first chunking accumulation value using the intermediate accumulation value transferred thereto.

Here, the operation for generating the chunking accumulation value may be an operation of adding the newly input intermediate accumulation value and the intermediate accumulation value stored in the second internal calculator 520.

The accumulation data transmission paths 550-2 may enable the output of any one of the second internal calculators 520 to be input to any one of the third internal calculators 530.

Accordingly, each of the second internal calculators 520 transfers the first chunking accumulation value to one of the adjacent third internal calculators 530 without storing the same in separate memory.

Accordingly, each of the third internal calculators 530 may receive the output of any one of the second internal calculators 520.

Each of the third internal calculators 530 may perform an operation for generating a second chunking accumulation value using the first chunking accumulation value transferred thereto.

Here, the operation for generating the chunking accumulation value may be an operation of adding the newly input first chunking accumulation value and the second chunking accumulation value stored in the third internal calculator 530.

The accumulation data transmission paths 550-3 may enable the output of any one of the third internal calculators 530 to be input to any one of the fourth internal calculators 540.

Accordingly, each of the third internal calculators 530 transfers the second chunking accumulation value to one of the adjacent fourth internal calculators 540 without storing the same in separate memory.

Accordingly, each of the fourth internal calculators 540 may receive the output of any one of the third internal calculators 530.

Each of the fourth internal calculators 540 may perform an operation for generating a third chunking accumulation value using the second chunking accumulation value transferred thereto.

Here, the operation for generating the third chunking accumulation value may be an operation of adding the newly input second chunking accumulation value and the third chunking accumulation value stored in the fourth internal calculator 540.

Here, although the operation for generating a chunking accumulation value is illustrated as being performed through three stages, this is merely an example for helping understanding of the embodiment, and the present disclosure is not limited thereto. That is, the operation for generating a chunking accumulation value may be performed through three or more stages depending on the number of internal calculators, or may be performed through only two stages, rather than using all of the internal calculators illustrated in FIG. 6.

To this end, the apparatus 500 for a multiplication operation based on an outer product according to an embodiment may further include a control unit (not illustrated) for inputting a control signal for adjusting the number of stages of the operation for generating a chunking accumulation value. According to another embodiment, the control signal may be transferred from an external control unit.

The number of stages of the operation for generating a chunking accumulation value may be adjusted depending on at least one of the type of data on which an outer-product-based multiplication operation is to be performed, the bit-width of a mantissa for representing the precision of data in a floating-point format, or various attributes including the characteristics of an application using the data, or a combination thereof.

Meanwhile, each of the first internal calculators 510 may perform a reset operation after it transfers the intermediate accumulation value to one of the second internal calculators 520 at every period corresponding to a first chunk size corresponding to the intermediate accumulation value.

For example, when a total of 10000 pieces of data are accumulated, the first internal calculators 510 are reset at every time period in which ten pieces of data are accumulated, thereby being reset a total of 1000 times.

Also, each of the second internal calculators 520 may perform an operation for generating the first chunking accumulation value at every period corresponding to the first chunk size.

That is, each of the second internal calculators 520 accumulates only the intermediate accumulation values received from one of the first internal calculators 510 at every period corresponding to the first chunk size, thereby generating a first chunking accumulation value.

Also, each of the second internal calculators 520 may perform a reset operation after it transfers the first chunking accumulation value to one of the third internal calculators 530 at every period corresponding to a size acquired by multiplying the first chunk size by a second chunk size, which is set for chunking accumulation of the first chunking accumulation value.

For example, when a total of 10000 pieces of data are accumulated, the second internal calculators 520 are reset at every time period in which a total of 100 pieces of data are accumulated by again accumulating ten accumulation values, each being acquired by accumulating ten pieces of data in the first internal calculators 510, thereby being reset a total of 100 times.

Also, each of the third internal calculators 530 may perform an operation for generating the second chunking accumulation value at every period corresponding to a size acquired by multiplying the first chunk size by the second chunk size, which is set for chunking accumulation of the first chunking accumulation value.

That is, each of the third internal calculators 530 accumulates only the first chunking accumulation values received from one of the second internal calculators 520 at every period corresponding to a size acquired by multiplying the first chunk size by the second chunk size, thereby generating a second chunking accumulation value.

Also, each of the third internal calculators 530 may perform a reset operation after it transfers the second chunking accumulation value to one of the fourth internal calculators 540 at every period corresponding to a size acquired by multiplying the first chunk size by the second chunk size.

For example, when a total of 10000 pieces of data are accumulated, the third internal calculators 530 are reset at every time period in which a total of 1000 pieces of data are accumulated by again accumulating ten accumulation values, each being acquired by accumulating ten accumulation values in the second internal calculators 520, thereby being reset a total of ten times.

Also, each of the fourth internal calculators 540 may perform an operation for generating a third chunking accumulation value at every period corresponding to a size acquired by multiplying the first chunk size, the second chunk size, and a third chunk size, which is set for chunking accumulation of the second chunking accumulation values.

That is, each of the fourth internal calculators 540 accumulates only the second chunking accumulation values received from one of the third internal calculators 530 at every period corresponding to a size acquired by multiplying the first chunk size, the second chunk size, and the third chunk size, which is set for chunking accumulation of the second chunking accumulation value, thereby generating a final accumulation value.

For example, when a total of 10000 pieces of data are accumulated, the fourth internal calculators 540 again accumulate ten accumulation values, each being acquired by accumulating ten accumulation values in the third internal calculators 530, thereby generating the final accumulation value in which a total of 10000 pieces of data are accumulated.

To this end, the apparatus 500 for a multiplication operation based on an outer product according to an embodiment may further include a control unit (not illustrated) for inputting a control signal for adjusting a chunk size corresponding to each of the first to third internal calculators or a period at which a reset operation is performed. According to another embodiment, the control signal may be transferred from an external control unit.

The first to third chunk sizes may be adjusted depending on at least one of the type of data on which an outer-product-based multiplication operation is to be performed, the bit-width of a mantissa for representing the precision of data in a floating-point format, or various attributes including the characteristics of an application using the data, or a combination thereof.

The time at which each of the first internal calculators 510 transfers the intermediate accumulation value and the time at which it is reset may be set based on the first chunk size.

The time at which each of the second internal calculators 520 performs the operation for generating the chunking accumulation value may be set depending on the first chunk size.

Here, each of the second internal calculators 520 may be set to be transitioned from an inactive state to an active state at every period corresponding to the first chunk size.

Also, the time at which each of the second internal calculators 520 transfers the first chunking accumulation value and the time at which it is reset may be set based on the first chunk size and the second chunk size.

The time at which each of the third internal calculators 530 performs an operation for generating the second chunking accumulation value may be set based on the first chunk size and the second chunk size.

Here, each of the third internal calculators 530 may be set to be transitioned from an inactive state to an active state at every period based on the first chunk size and the second chunk size.

Also, the time at which each of the third internal calculators 530 transfers the second chunking accumulation value and the time at which it is reset may be set based on the first to third chunk sizes.

The time at which each of the fourth internal calculators 540 performs an operation for generating the third chunking accumulation value may be set based on the first to third chunk sizes.

Here, each of the fourth internal calculators 540 may be set to be transitioned from an inactive state to an active state at every period based on the first to third chunk sizes.

As described above, a chunking accumulation method is performed through multiple stages using the second to fourth internal calculators 520 to 540, whereby hardware utilization may be improved. Also, an information loss rate of an accumulation result, which is caused by an excessively large or small value, among the input values of the operation, may be reduced through in-depth accumulation. Accordingly, an operation result having a reduced quantization error may be acquired, whereby the accuracy of training and inference using the operation result may be improved.

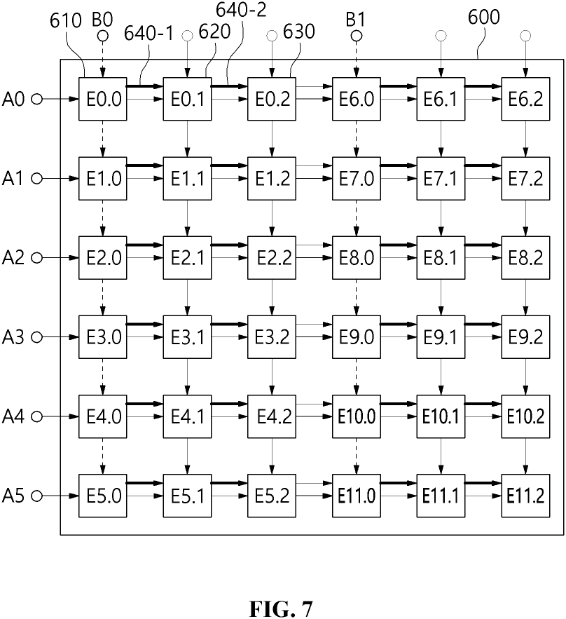

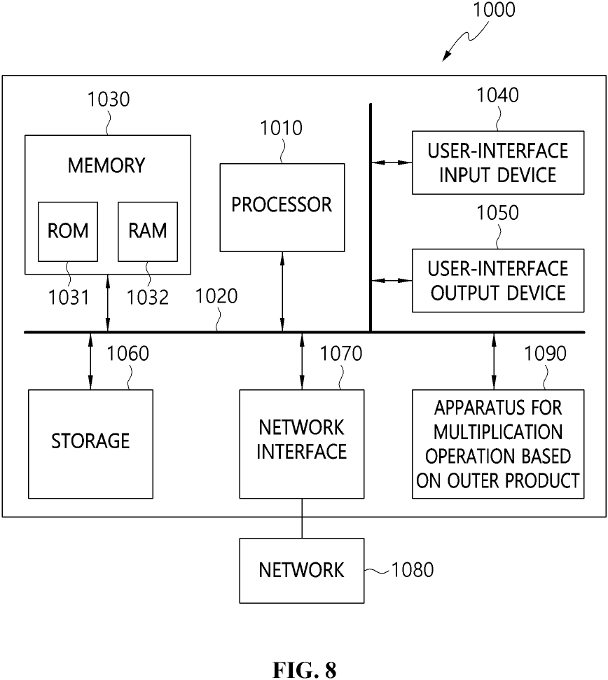

FIG. 7 is an internal configuration diagram of an apparatus for a multiplication operation based on an outer product according to a further embodiment.

Referring to FIG. 7, the apparatus 600 for a multiplication operation based on an outer product according to a further embodiment is an embodiment implemented whereby an embodiment for performing an operation of generating a chunking accumulation value through multiple stages, as illustrated in FIG. 6, is applied to another embodiment for performing matrix-matrix multiplication, as in the apparatus 600 for a multiplication operation based on an outer product, illustrated in FIG. 3.

For example, the apparatus 600 for a multiplication operation based on an outer product sequentially receives vector data of a first matrix through input ports A0 to A5 and sequentially receives vector data of a second matrix through input ports B0 to B1, thereby performing a matrix-matrix multiplication operation.

The apparatus 600 for a multiplication operation based on an outer product according to a further embodiment includes first internal calculators 610 and second internal calculators 620, and accumulation data transmission paths 640-1 may be formed between the first internal calculators 610 and the second internal calculators 620.

Also, the apparatus 600 for a multiplication operation based on an outer product according to a further embodiment includes third internal calculators 630, and accumulation data transmission paths 640-2 may be formed between the second internal calculators 620 and the third internal calculators 630.

Also, the first internal calculators 610 may indicate calculators that receive data from two external input ports in FIG. 7, for example, E0.0, E1.0, ..., E11.0, the second internal calculators 620 may indicate calculators that receive data from the adjacent first internal calculators 610, rather than from the external input ports, in FIG. 7, that is, E0.1, E1.1, ..., E11.1, and the third internal calculators 630 may indicate calculators that receive data from the adjacent second internal calculators 620, rather than from the external input ports, in FIG. 7, that is, E0.2, E1.2, ..., E11.2.

That is, the apparatus 600 for a multiplication operation based on an outer product according to an embodiment adds only the accumulation data transmission paths 640-1 and 640-2 and minimizes additional other components when configuring hardware for a chunking accumulation operation. Accordingly, a problem caused by a chunking accumulation operation may be solved while using the structure of the conventional apparatus for a multiplication operation based on an outer product..

Furthermore, the apparatus 600 for a multiplication operation based on an outer product according to another embodiment uses the second internal calculators 620 and the third internal calculators 630 for high-order accumulation when it performs a matrix-matrix multiplication operation, thereby increasing utilization of the internal calculators and further reducing a quantization error, which is a problem with a chunking accumulation operation.

Because the operations of the first to third internal calculators 610 to 630 are the same as the operations of the first to third internal calculators 510 to 530 illustrated in FIG. 6, a detailed description thereof will be omitted.

However, the third internal calculators 630 illustrated in FIG. 7 do not transfer the second chunking accumulation value to one of the adjacent internal calculators but output the same to external memory as the final accumulation value.

FIG. 8 is a view illustrating a computer system configuration according to an embodiment.

A system to which the apparatus 1090 for a multiplication operation based on an outer product according to an embodiment is applied may be implemented in a computer system 1000 including a computer-readable recording medium.

The computer system 1000 may be an AI system for training a neural network or performing inference through the neural network. Here, the apparatus 1090 for a multiplication operation based on an outer product may be used for accelerated operation of the neural network when training and inference are performed. That is, the apparatus 1090 for a multiplication operation based on an outer product may perform a neural network operation through outer-product-based multiplication under the control of the processor 1010 when feature map data and neural network parameters (e.g., weight data) are input.

Here, the apparatus 1090 for a multiplication operation based on an outer product may perform the operation described above with reference to FIGS. 3, 4, 6, and 7.

The computer system 1000 may include one or more processors 1010, memory 1030, a user-interface input device 1040, a user-interface output device 1050, and storage 1060, which communicate with each other via a bus 1020. Also, the computer system 1000 may further include a network interface 1070 connected to a network 1080. The processor 1010 may be a central processing unit or a semiconductor device for executing a program or processing instructions stored in the memory 1030 or the storage 1060. The memory 1030 and the storage 1060 may be storage media including at least one of a volatile medium, a nonvolatile medium, a detachable medium, a non-detachable medium, a communication medium, or an information delivery medium, or a combination thereof. For example, the memory 1030 may include ROM 1031 or RAM 1032.

According to an embodiment, the processor 1010 may drive the apparatus 1090 for a multiplication operation based on an outer product, and may control input/output of data and quantization of input data.

According to the disclosed embodiment, the accuracy of an accumulation operation of a neural network using a low-precision data format in an AI processor may be compensated for.

According to the disclosed embodiment, when a chunking accumulation method is applied in an AI processor, a problem in which the speed of training and inference is decreased by frequent memory access may be solved.

According to the disclosed embodiment, a problem in which a hardware area is expanded due to a chunking accumulation operation in an AI processor may be solved. That is, the structure of a conventional outer-product-based matrix multiplication calculator may be reused without change.

According to the disclosed embodiment, the utilization of an accelerator may reach a maximum of 100% by a vector-matrix multiplication operation. In the case of a vector-matrix multiplication operation, a deactivated internal calculator (e.g., an FPU) is used for a multi-accumulation operation, whereby the utilization of a calculator may be increased to 100%. Also, because the structure enables two or more stages of chunking accumulation, there is an effect of reducing a quantization error.

The disclosed embodiment may be widely used for fast operation speed and low power consumption when a low-precision operation is performed in an AI semiconductor. Also, because chunking accumulation is an essential operation in this process, a hardware structure for accelerating chunking accumulation will be used for various types of AI semiconductors and has high marketability and the possibility of commercialization.

Although embodiments of the present disclosure have been described with reference to the accompanying drawings, those skilled in the art will appreciate that the present disclosure may be practiced in other specific forms without changing the technical spirit or essential features of the present disclosure. Therefore, the embodiments described above are illustrative in all aspects and should not be understood as limiting the present disclosure.

What is claimed is:

1. An apparatus for a multiplication operation based on an outer product, comprising:
first internal calculators, each of which generates an intermediate accumulation value by performing a Multiply-Accumulate (MAC) operation;
second internal calculators, each of which generates a chunking accumulation value using the intermediate accumulation value; and
accumulation data transmission paths for enabling output of any one of the first internal calculators to be input to any one of the second internal calculators.

2. The apparatus of claim 1, wherein each of the second internal calculators receives output of any one of the first internal calculators.

3. The apparatus of claim 1, wherein each of the first internal calculators performs a reset operation after transferring the intermediate accumulation value to one of the second internal calculators at every period corresponding to a chunk size corresponding to the intermediate accumulation value.

4. The apparatus of claim 3, wherein each of the second internal calculators performs an operation for generating the chunking accumulation value at every period corresponding to the chunk size.

5. The apparatus of claim 4, wherein the operation for generating the chunking accumulation value is an operation of adding a newly input intermediate accumulation value and an intermediate accumulation value stored in the second internal calculator.

6. The apparatus of claim 4, further comprising:
a control unit for inputting a control signal for adjusting the chunk size to each of the first internal calculators and the second internal calculators.

7. The apparatus of claim 4, wherein each of the second internal calculators is transitioned from an inactive state to an active state at every period corresponding to the chunk size.

8. A method for a multiplication operation based on an outer product, comprising:
generating, by each of first internal calculators, an intermediate accumulation value by performing a Multiply-Accumulate (MAC) operation;
transmitting the intermediate accumulation value to one of second internal calculators through an accumulation data transmission path; and
generating, by each of the second internal calculators, a chunking accumulation value using the intermediate accumulation value.

9. The method of claim 8, wherein transmitting the intermediate accumulation value comprises performing a reset operation after transferring the intermediate accumulation value to one of the second internal calculators at every period corresponding to a chunk size corresponding to the intermediate accumulation value.

10. The method of claim 9, wherein generating the chunking accumulation value comprises performing an operation for generating the chunking accumulation value at every period corresponding to the chunk size.

11. The method of claim 10, wherein the operation for generating the chunking accumulation value is an operation of adding a newly input intermediate accumulation value and an intermediate accumulation value stored in the second internal calculator.

12. The method of claim 10, further comprising:
before generating the chunking accumulation value,
transitioning each of the second internal calculators from an inactive state to an active state at every period corresponding to the chunk size.

13. An apparatus for a multiplication operation based on an outer product, comprising:
first internal calculators, each of which generates an intermediate accumulation value by performing a Multiply-Accumulate (MAC) operation;
second internal calculators, each of which generates a first chunking accumulation value using the intermediate accumulation value;
third internal calculators, each of which generates a second chunking accumulation value using the first chunking accumulation value;
first accumulation data transmission paths for enabling output of any one of the first internal calculators to be input to any one of the second internal calculators; and
second accumulation data transmission paths for enabling output of any one of the second internal calculators to be input to any one of the third internal calculators.

14. The apparatus of claim 13, wherein:
each of the second internal calculators receives output of any one of the first internal calculators, and
each of the third internal calculators receives output of any one of the second internal calculators.

15. The apparatus of claim 13, wherein:
each of the first internal calculators performs a reset operation after transferring the intermediate accumulation value to one of the second internal calculators at every period corresponding to a first chunk size corresponding to the intermediate accumulation value, and
each of the second internal calculators performs a reset operation after transferring the first chunking accumulation value to one of the third internal calculators at every period corresponding to a size acquired by multiplying the first chunk size by a second chunk size, which is set for chunking accumulation of the first chunking accumulation value.

16. The apparatus of claim 13, wherein:
each of the second internal calculators performs an operation for generating the first chunking accumulation value at every period corresponding to a first chunk size, and
each of the third internal calculators performs an operation for generating the second chunking accumulation value at every period corresponding to a size acquired by multiplying the first chunk size by a second chunk size, which is set for chunking accumulation of the first chunking accumulation value.

17. The apparatus of claim 16, wherein:
the operation for generating the first chunking accumulation value is an operation of adding a newly input intermediate accumulation value and an intermediate accumulation value stored in the second internal calculator, and
the operation for generating the second chunking accumulation value is an operation of adding a newly input first chunking accumulation value and a second chunking accumulation value stored in the third internal calculator.

18. The apparatus of claim 16, further comprising:
a control unit for inputting a control signal for adjusting a chunk size corresponding to each of the first to third internal calculators or a period at which a reset operation is performed.

19. The apparatus of claim 16, wherein:
each of the second internal calculators is transitioned from an inactive state to an active state at every period corresponding to the first chunk size, and
each of the third internal calculators is transitioned from an inactive state to an active state at every period calculated based on the first chunk size and the second chunk size.

20. The apparatus of claim 16, wherein:
(N+3)-th internal calculators, each of which performs an operation for generating an (N+2)-th chunking accumulation value using an (N+1)-th chunking accumulation value, and accumulation data transmission paths for enabling output of any one of (N+2)-th internal calculators to be input to any one of the (N+3)-th internal calculators are repeatedly added as N increases (N being an integer increasing by 1 from 1), and
the operation for generating the (N+2)-th chunking accumulation value is an operation of adding a newly input (N+1)-th chunking accumulation value and an (N+2)-th chunking accumulation value stored in the (N+3)-th internal calculator.
